(19) United States
(12) Patent Application Publication
(10) Pub. No.: US 2007/0002394 A1
(43) Pub. Date: Jan. 4, 2007

(54) Image reading apparatus and computer readable medium storing computer program

(76) Inventor: Ryousuke Okajima, Tokyo (JP)

Correspondence Address: CANTOR COLBURN, LLP, 55 GRIFFIN ROAD SOUTH, BLOOMFIELD, CT, 06002, US

(21) Appl. No.: 11/237,998

(22) Filed: Sep. 28, 2005

(30) Foreign Application Priority Data
Jun. 30, 2005 (JP) 2005-191903

(51) Int. Cl. H04N 1/04

(52) U.S. Cl. 358/474; 358/1.2

(57) ABSTRACT

An image reading apparatus includes: an image reading section for reading an original and for generating image data for the original; an original size obtaining section for obtaining a size of the original; and an image file generation section for setting a page frame which has a size equal to the size of the original obtained by the original size obtaining section, and for generating an image file including the set page frame and the image data.

### BACKGROUND OF THE INVENTION

1. Field of the Invention

This invention relates to an image reading apparatus and a program in a computer readable medium.

2. Description of the Related Art

Image reading apparatuses have conventionally been incorporated in many image processing apparatuses, such as copy machines, scanners, and facsimiles, for use. With such image reading apparatuses, because of, for example, a restriction based on mechanical structure or a dimensional error of each assembly, it may be impossible to read an edge of an original to be read (hereinafter an area which cannot be read will be referred to as an unreadable area). In this case, the size of image data generated differs from that of the original. That is to say, even if the size of the original is standard (A4, for example), the size of image data generated is non-standard and is smaller than A4. Therefore, in a printing process performed later, a print error may occur because there is no appropriate printing paper size in a printer.

Accordingly, a technique for generating an image the size of which is the same as that of an image on an original from image data read or a technique for performing image processing, such as enlargement, so as to generate an image the size of which is the same as that of an image on an original from image data read has conventionally been proposed. Furthermore, a flat-bed image reading apparatus which outputs a reading result with changing the size by using a correction coefficient for correcting a reading area is proposed (see JP-Tokukai-Hei-8-274972 which is hereinafter referred to as “patent document 1”).

However, the size of an image generated from image data read becomes smaller than the size of an image on an original. Accordingly, with the above technique for generating an image the size of which is the same as that of an image on an original from image data read, a large capacity memory and a long time are required for performing a process. With the technique for performing enlargement so as to generate an image the size of which is the same as that of an image on an original from image data read, it is impossible to equalize the size of the image generated from the image data read with that of the image on the original. Moreover, with these techniques, image processing, such as adding image data or enlarging, is performed on the image data read, so the amount of image data generated increases.

In addition, with the image reading apparatus disclosed in the patent document 1, the relationship between image data read and an image on an original is not taken into consideration; therefore, it is impossible to equalize the size of an image generated with the size of the image on the original or the position of the image generated with the position of the image on the original.

### SUMMARY

The present invention was made under the background circumstances described above. An object of the present invention is to provide an image reading apparatus and program capable of outputting image data which is generated by reading an original and the size and/or position of which is the same as the size and/or position of an image on the original.

To solve the above problem, in accordance with an embodiment reflecting the first aspect of the present invention, an image reading apparatus comprises:

an image reading section for reading an original and for generating image data for the original;

an original size obtaining section for obtaining a size of the original; and

an image file generation section for setting a page frame which has a size equal to the size of the original obtained by the original size obtaining section, and for generating an image file including the set page frame and the image data.

Preferably, the original size obtaining section includes a sensor for detecting the size of the original.

Preferably, the image file generation section places the image data in the page frame based on a designated frame deletion size to generate the image file.

Preferably, the image file generation section obtains an unreadable area size for the image reading section and places the image data in the page frame based on the unreadable area size to generate the image file.

Preferably, the apparatus further comprises an unreadable area size storage section which stores in advance the unreadable area size for the image reading section, wherein the image file generation section obtains the unreadable area size from the unreadable area size storage section.

Preferably, the image file generation section places the image data in the page frame based on the unreadable area size obtained based on difference between an image size and the size of the original to generate the image file.

Preferably, the image file generation section generates the image file based on the frame deletion size or the unreadable area size, whichever is greater.

Preferably, the image file generation section sets a page frame which has a size equal to the size of the original changed based on a magnification value designated and generates an image file including the page frame and image data generated according to the magnification value.

Preferably, the apparatus further comprises a magnification change table storage section for storing a magnification change table in which the magnification value is associated with an original size corresponding to the magnification value for each original size type,

wherein the image file generation section changes the size of the original based on the magnification change table.

Preferably, the image file is generated in a PDF format.

In accordance with an embodiment reflecting the second aspect of the invention, an image reading apparatus comprises:

an image reading section for reading an original and for generating image data; and

an image file generation section for setting a page frame having a standard paper size and for generating an image file including the set page frame and the image data.

Preferably, the apparatus further comprises an original size obtaining section for obtaining the standard paper size, wherein the image file generation section sets the page frame based on the standard paper size obtained by the original size obtaining section.

Preferably, the original size obtaining section includes a sensor for detecting a standard paper size of the original.

Preferably, the image file generation section places the image data in the page frame based on a designated frame deletion size to generate the image file.

Preferably, the image file generation section obtains an unreadable area size for the image reading section and places the image data in the page frame based on the unreadable area size to generate the image file.

Preferably, the apparatus further comprises an unreadable area size storage section which stores in advance the unreadable area size for the image reading section, wherein the image file generation section obtains the unreadable area size from the unreadable area size storage section.

Preferably, the image file generation section places the image data in the page frame based on the unreadable area size obtained based on difference between an image size and the standard paper size to generate the image file.

Preferably, the image file generation section generates the image file based on the frame deletion size or the unreadable area size, whichever is greater.

Preferably, the image file generation section sets a page frame which has a size equal to the standard paper size changed based on a magnification value designated and generates an image file including the page frame and image data generated according to the magnification value.

Preferably, the apparatus further comprises a magnification change table storage section for storing a magnification change table in which the magnification value is associated with an original size corresponding to the magnification value for each original size type,

wherein the image file generation section changes a size of the original based on the magnification change table.

Preferably, the image file is generated in a PDF format.

In accordance with an embodiment reflecting the third aspect of the invention, a computer readable medium storing a computer program that causes a computer to perform a method of:

obtaining image data from an image reading section;

obtaining a size of an original; and

setting a page frame which has a size equal to the size of the original obtained, and generating an image file including the set page frame and the image data.

In accordance with an embodiment reflecting the fourth aspect of the invention, a computer readable medium storing a computer program that causes a computer to perform a method of:

obtaining image data from an image reading section;

obtaining a standard paper size; and

setting a page frame which has a size equal to the standard paper size obtained, and generating an image file including the set page frame and the image data.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a schematic view showing the structure of an image formation apparatus;

FIG. 2 is a block diagram showing the structure of a reading control system in a first embodiment;

FIG. 3 is a flow chart showing the procedure for an original reading process performed in the first embodiment;

FIG. 4 is a flow chart showing the procedure for a PDF file generation process performed in the first embodiment;

FIG. 5 is a view showing an example of an unreadable area and a frame deletion area on an original;

FIG. 6 is a view showing an example of a one-page command in a PDF file;

FIG. 7 is a view showing an example of a PDF file generated by a PDF generation section;

FIG. 8 is a view showing an example of a one-page command in a PDF file;

FIG. 9 is a view showing an example of a PDF file generated by the PDF generation section;

FIG. 10 is a block diagram showing the structure of a reading control system in a second embodiment;

FIG. 11 is a view showing an example of a magnification change table stored in a storage unit;

FIG. 12 is a flow chart showing the procedure for an original reading process performed in the second embodiment; and

FIG. 13 is a flow chart showing the procedure for a PDF file generation process performed in the second embodiment.

### DETAILED DESCRIPTION OF PREFERRED EMBODIMENTS

Embodiments of the present invention will now be described in detail with reference to the drawings. However, the present invention is not limited to the embodiments hereinafter explained.

### First Embodiment

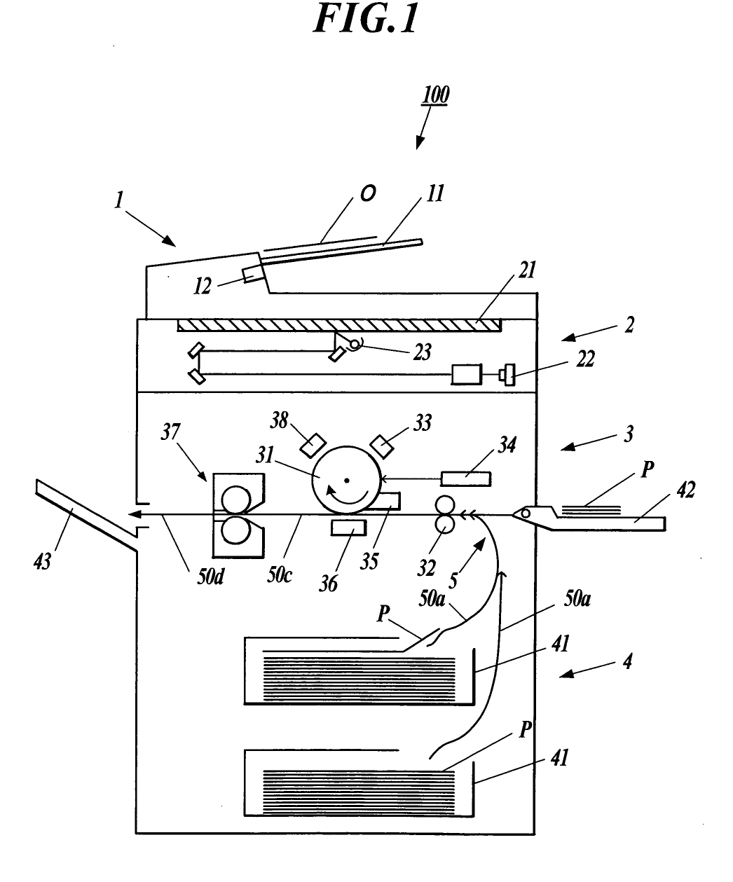

FIG. 1 is a schematic view showing the structure of an image formation apparatus 100 according to a first embodiment of the present invention. The image formation apparatus 100 is, for example, a copy machine, a printer, a facsimile, or a composite machine having these functions and forms an image on recording paper P by electrophotography.

As shown in FIG. 1, the image formation apparatus 100 comprises an original feed section 1, an image reading section 2, an image formation section 3, a paper supply section 4, and a feed section 5.

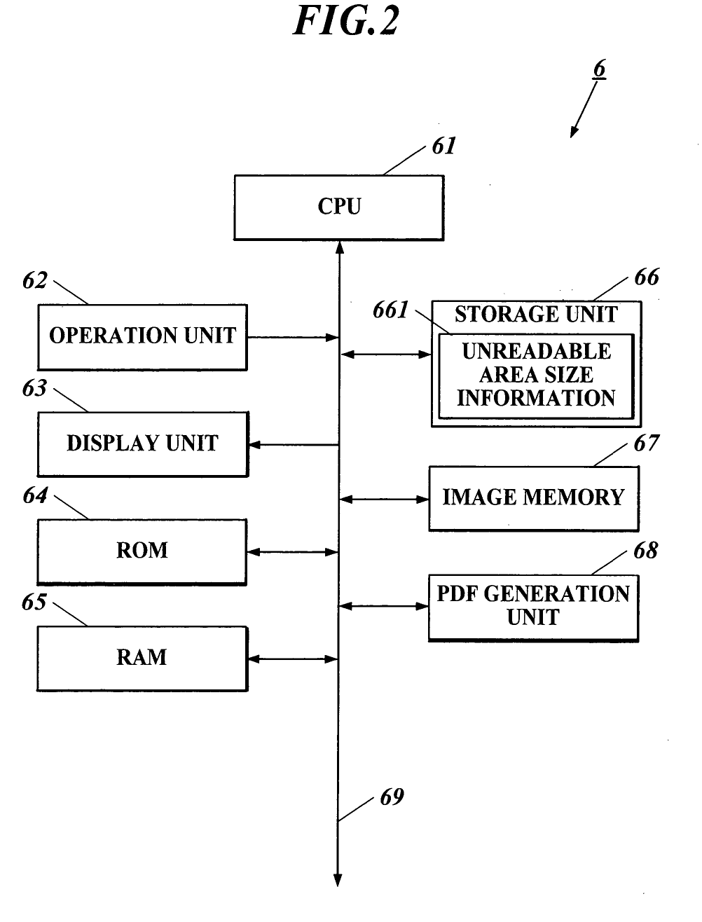

The original feed section 1 includes an original feed unit 11, an original detection sensor 12, and an original feed mechanism (not shown). The original feed mechanism feeds originals O placed on the original feed unit 11 to the image reading section 2 one by one. The original detection sensor 12 detects the size (A3, A4, B4, or the like) of each original on the basis of the positions of its edge portions and outputs a detection signal to a CPU 61 described later (see FIG. 2). The size (standard size) of an original can be obtained from the original detection sensor 12 in this way, so a user can use the image formation apparatus 100 without knowing its size.

The image reading section 2 includes a charge-coupled device (CCD) image sensor 22 and a light source 23 under transparent contact glass 21 on which an original with an image formed thereon fed from the original feed section 1 is placed. The driving of the CCD image sensor 22 etc. is controlled by a scanner control section (not shown) and an image formed on the original O placed on the contact glass 21 is read. To be concrete, the original O is scanned by light emitted from the light source 23, reflected light is directed onto the CCD image sensor 22 by a lens system, the CCD image sensor 22 makes a photoelectric conversion according to the amount of light it receives to generate image data, and the image data is outputted to the CPU 61 described later (see FIG. 2).

The image read by the image reading section 2 is not limited to a graphic image or a photo image. For example, it may include a text image, such as letters or symbols. The user may directly place the original O on the contact glass 21 instead of feeding it from the original feed section 1.

The image formation section 3 includes a registration roller 32, a charging unit 33, an LD unit 34, a development unit 35, a transfer unit 36, a fixation unit 37, and a cleaning unit 38 around a rotatable photosensitive drum 31.

The rotation of the registration roller 32 is controlled by a drive unit (not shown). The registration roller 32 feeds the recording paper P fed by the feed section 5 to the photosensitive drum 31, and corrects a slip in the sub scanning direction and a paper inclination or tilt.

The charging unit 33 performs a corona discharge on the surface of the photosensitive drum 31 to uniformly charge it.

The LD unit 34 including a laser diode (LD) light source is located in the main scanning direction of the photosensitive drum 31 on the downstream side in the rotational direction of the photosensitive drum 31 from the charging unit 33. By performing image exposure on the surface of the photosensitive drum 31 on the basis of image signals, the LD unit 34 makes charges in an area on the surface of the photosensitive drum 31 which is exposed to light decay and disappear to form an electrostatic latent image. The LD unit 34 includes a drive circuit (not shown). The CPU 61 described later (see FIG. 2) controls the driving of the drive circuit to turn on/off the LD unit 34.

The development unit 35 is located on the downstream side in the rotational direction of the photosensitive drum 31 from the LD unit 34. The development unit 35 adheres toner having the same electrical polarity as the photosensitive drum 31 by charging to the electrostatic latent image formed on the surface of the photosensitive drum 31.

The transfer unit 36 is located on the downstream side in the rotational direction of the photosensitive drum 31 from the development unit 35. A paper feed path 50c along which the recording paper P is fed is located between the transfer unit 36 and the photosensitive drum 31. The transfer unit 36 presses the recording paper P against the photosensitive drum 31. Accordingly, the recording paper P is charged and the toner adsorbs onto the recording paper P. As a result, a toner image is transferred. The charged recording paper P is then neutralized to separate the recording paper P from the photosensitive drum 31.

The fixation unit 37 is located on the downstream side of the paper feed path 50c from the transfer unit 36. The fixation unit 37 fixes the toner which has melted with heat on the recording paper P and fixes the toner image on the recording paper P.

The cleaning unit 38 is located on the downstream side in the rotational direction of the photosensitive drum 31 from the transfer unit 36. The cleaning unit 38 is pressed against the surface of the photosensitive drum 31 to remove residual toner and to clean the surface of the photosensitive drum 31.

The paper supply section 4 includes a plurality of paper feed trays 41 and a manual paper feed tray 42 where the recording paper P is housed or placed. The recording paper P housed in the paper feed tray 41 or placed on the manual paper feed tray 42 is supplied to the image formation section 3 via a paper feed path 50a. In FIG. 1, two paper feed trays 41 are located below the image formation section 3 with one under the other. However, the number and arrangement of the paper feed trays 41 are not limited to the case shown in FIG. 1. The manual paper feed tray 42 is fixed to a side of the image formation apparatus 100. Similarly, a paper feed tray which can house many sheets of recording paper P may be fixed to the side of the image formation apparatus 100.

The feed section 5 includes the paper feed paths 50a and 50c, paper feed paths 50b and 50d, and a paper feed roller (not shown). The recording paper P is fed from the paper supply section 4 to each unit in the image formation section 3 along the paper feed paths 50a, 50b, and 50c. The recording paper P on which the image is formed is delivered from the image formation section 3 to a delivery tray 43 along the paper feed path 50d.

FIG. 2 is a view showing a control system (hereinafter referred to as a reading control system 6) for the original feed section 1 and the image reading section 2. In FIG. 2, the reading control system 6 includes the CPU 61, an operation unit 62, a display unit 63, a ROM 64, a RAM 65, a storage unit 66, an image memory 67, and a PDF generation unit 68 which are connected to one another via a bus 69.

The CPU 61 exercises central control over each section in an image forming apparatus 100. The CPU 61 reads a system program stored in the ROM 64 or the storage unit 66, reads a program designated from among various application programs stored in the ROM 64 or the storage unit 66, loads these programs into the RAM 65, and performs various processes in cooperation with the programs loaded into the RAM 65.

To be concrete, the CPU 61 stores the image data read by the image reading section 2 in the image memory 67 and obtains the image size of the image data.

The CPU 61 also obtains an unreadable area size for the image reading section 2 stored in the storage unit 66.

Moreover, the CPU 61 controls the PDF generation unit 68 to make the PDF generation unit 68 generate a PDF file.

In addition, the CPU 61 controls each unit in the image formation section 3 to record a PDF file stored in the image memory 67 on the recording paper P.

The operation unit 62 includes input keys. The operation unit 62 accepts information inputted by a user as an input signal and outputs it to the CPU 61. The display unit 63 includes a liquid crystal display (LCD) and displays various pieces of information in accordance with display signals sent from the CPU 61. The display unit 63 and the operation unit 62 may be integrated into a touch panel.

To be concrete, in the operation unit 62, a frame deletion size which negates the reading of the periphery of the original O can be designated by predetermined operation. A frame deletion size inputted by the user is outputted to the CPU 61.

Furthermore, in the operation unit 62, making a paper size generation function described later valid or not making a paper size generation function described later valid can be designated selectively by predetermined operation. A selection result inputted by the user is outputted to the CPU 61. The CPU 61 sets conditions for an original reading process described later by temporarily storing the above set values designated in the RAM 65.

The ROM 64 stores various programs which the image forming apparatus 100 needs for operating and data which the image formation apparatus 100 needs for executing these programs. The RAM 65 stores various programs to be executed by the CPU 61 in a program storage area. In addition, the RAM 65 temporarily stores data, such as processing results, obtained at the time of executing the program in a work area. In this case, the program is stored in the form of a computer readable program code and the CPU 61 performs operation in accordance with the program code.

The storage unit 66 is a nonvolatile semiconductor memory, such as an electrically erasable programmable read-only memory (EEPROM), and stores in advance unreadable area size information 661 indicative of the unreadable area size for the image reading section 2. The unreadable area size is stored in advance in the storage unit 66, so the unreadable area size for the image reading section 2 can easily be obtained.

The image memory 67 is, for example, a hard disk drive (HDD) and stores the image data read by the image reading section 2. The image memory 67 also stores a PDF file generated by the PDF generation unit 68. The image formation section 3 performs an image formation process on the basis of the image data or the PDF file stored in the image memory 67.

The PDF generation unit 68 is a logic circuit, such as an application specific integrated circuit (ASIC). On the basis of the image data stored in the image memory 67, the PDF generation unit 68 generates a PDF file under the control of the CPU 61. In this case, a PDF file is data generated in the PDF. The function of the PDF generation unit 68 may be realized with the cooperation of the CPU 61 and a predetermined processing program stored in the storage unit 66.

The operation of the image formation apparatus 100 according to the first embodiment will now be described.

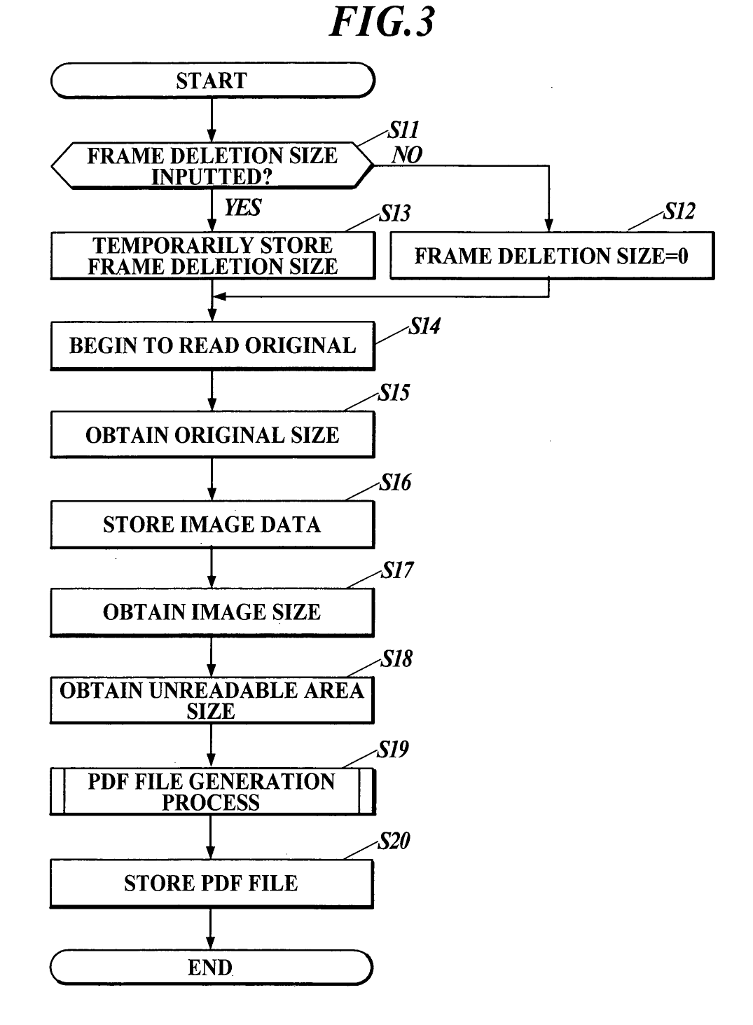

The procedure for an original reading process performed by the image formation apparatus 100 according to the first embodiment will be described with reference to FIG. 3. Each process shown in FIG. 3 is performed with the cooperation of the CPU 61 and a predetermined program stored in the ROM 64. It is assumed that the original O to be read is placed on the original feed unit 11.

Whether a frame deletion size has been inputted via the operation unit 62 is determined first (step S11) before the reading of the original O is begun. If the determination that a frame deletion size has not been inputted is made (No in step S11), then “frame deletion size=0” is temporarily stored in the RAM 65 (step S12) and step S14 is performed. If the determination that a frame deletion size has been inputted is made (Yes in step S11), then the frame deletion size which has been inputted is temporarily stored in the RAM 65 (step S13) and step S14 is performed.

The reading of an image on the original O is then begun in accordance with an operation signal inputted via the operation unit 62 for giving instructions to begin to read (step S14). When an original size of the original O detected by the original detection sensor 12 is obtained, this original size is temporarily stored in the RAM 65 (step S15). When the original O is fed to the image reading section 2 by an original feed mechanism (not shown), image data is generated by the image reading section 2 and is stored in the image memory 67 (step S16).

The image size of the image data stored in the image memory 67 is then obtained and is temporarily stored in the RAM 65 (step S17). The unreadable area size stored in the storage unit 66 is obtained and is temporarily stored in the RAM 65 (step S18). A PDF file generation process in step S19 is performed.

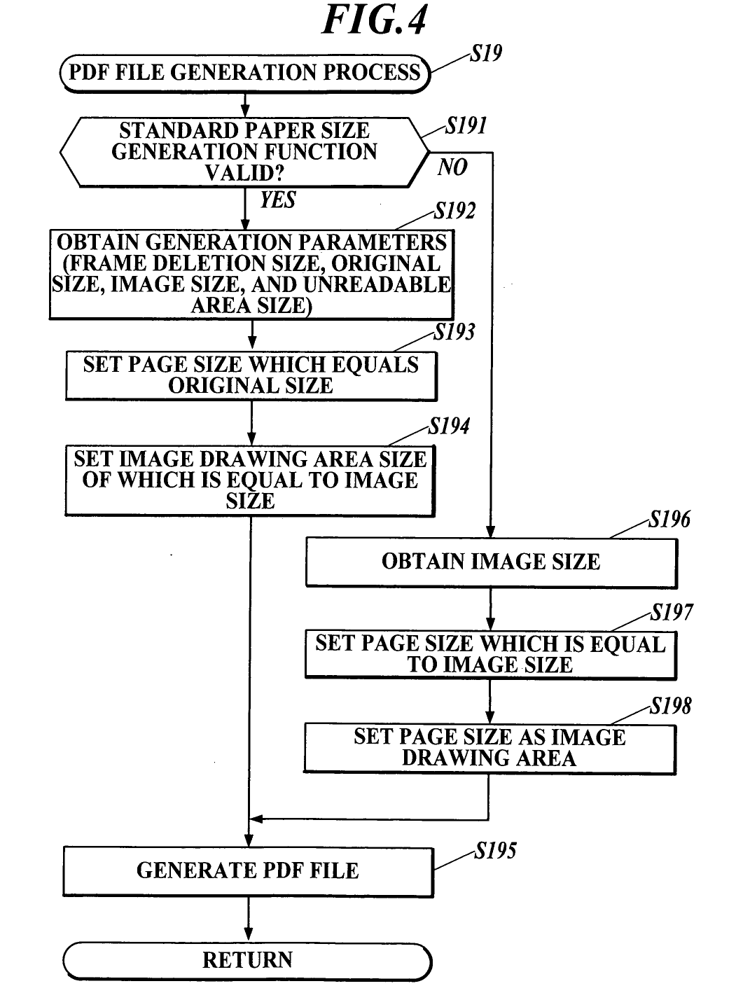

The PDF file generation process performed in step S19 will now be described with reference to FIG. 4. This process is performed by the PDF generation unit 68 under the control of the CPU 61.

Whether the paper size generation function is set to “valid” by a user via the operation unit 62 is determined first. If the determination that the paper size generation function is set to “valid” is made (Yes in step S191), then the generation parameters (frame deletion size, original size, image size, and unreadable area size) temporarily stored in the RAM 65 are obtained (step S192). A page size which equals the original size is set (step S193). In this case, a page size is the size of a page frame in a PDF file to be generated by the PDF generation unit 68 and corresponds to a paper size in the case of printing and a display area size in the case of displaying.

On the basis of the unreadable area size and the frame deletion size, an image drawing area the size of which is equal to the image size is then set at a predetermined position in the page size (step S194). On the basis of the page size and image drawing area set, the PDF file in which the image data is placed in the image drawing area is generated (step S195) and then step S20 in FIG. 3 is performed.

In the step S20 in FIG. 3, the PDF file generated in step S19 is stored in the image memory 67 and the original reading process ends. In the case of printing, the image formation section 3 forms an image included in the PDF file stored in the image memory 67 at a position based on drawing instruction information on the recording paper P the size of which corresponds to the above page size under the control of the CPU 61.

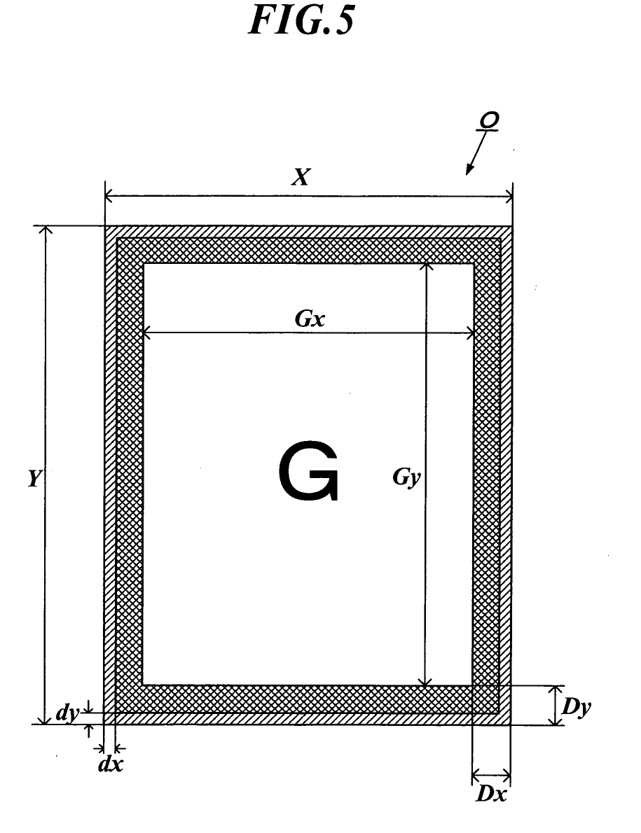

Operation performed in the original reading process and the PDF file generation process (steps S192 through S195) will now be described with reference to FIGS. 5 through 7.

FIG. 5 is a view showing an example of an unreadable area and a frame deletion area on the original O. In FIG. 5, X and Y indicate the original sizes in the horizontal and vertical directions, respectively, of the original O. These values are obtained in step S15 of the above original reading process.

An area G indicates an area read by the image reading section 2, that is to say, the image data generated by the image reading section 2. This image data is stored in the image memory 67 in step S16 of the above original reading process.

In FIG. 5, symbols Gx and Gy indicate the image sizes in the horizontal and vertical directions, respectively, of the image data G. Symbols dx and dy indicate the sizes in the horizontal and vertical directions, respectively, of the unreadable area. Symbols Dx and Dy indicate the sizes in the horizontal and vertical directions, respectively, of the frame deletion area. These generation parameter values are obtained in steps S13, S17, and S18, respectively, of the above original reading process.

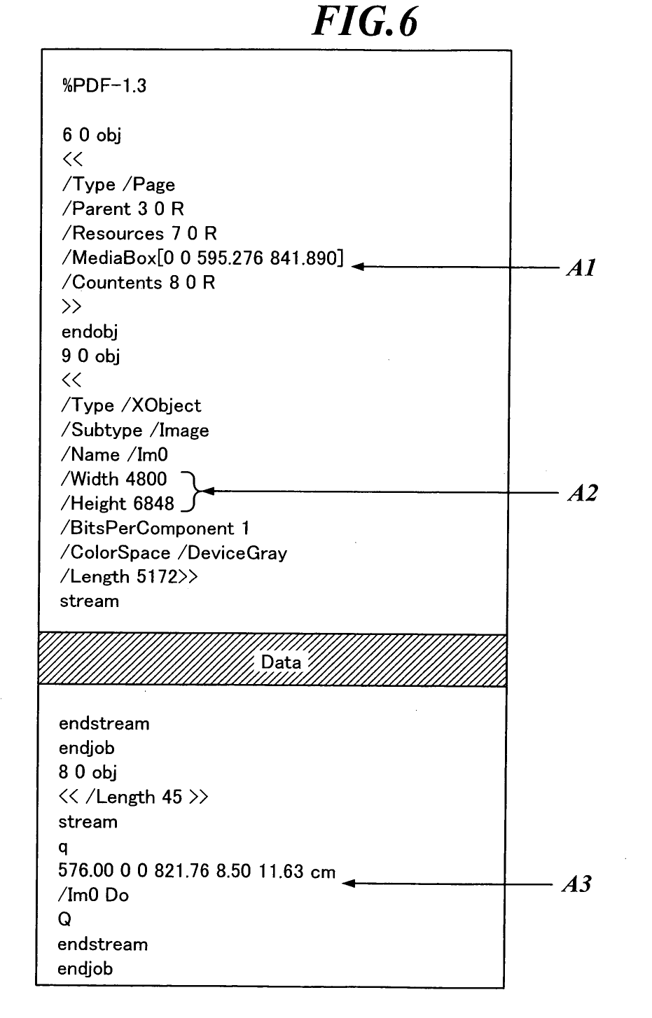

FIG. 6 is a view showing an example of a one-page command in a PDF file generated in the PDF file generation process. It is assumed that this one-page command is described at a predetermined place in data in the PDF file prescribed in the PDF. In addition, in this embodiment it is assumed that the original size, the unreadable area sizes dx and dy, and the frame deletion sizes Dx and Dy of the original O, being the generation parameters for the PDF file, are A4, 1 mm, 1 mm, 3 mm, and 3 mm, respectively.

In FIG. 6, values obtained by converting the original size A4 by 72 dpi are set in the command “/MediaBox” indicated by A1. That is to say, the command “/MediaBox” expresses the page size of the PDF file and size which is the same as the original size is set as the page size.

Values set in the command “/MediaBox” indicate the positions of the beginning and end of the page size. The first “0 0” indicate the positions in the horizontal and vertical directions, respectively, of the beginning of the page size by coordinates. “595.276 841.890” indicate the positions in the horizontal and vertical directions, respectively, of the end of the page size by coordinates. A rectangular area where a diagonal is a line segment which joins these two end points corresponds to the page size A4. The unit of the values which indicate the positions of the beginning and end of the page size is dots per inch.

The image sizes Gx=4800 and Gy=6848 are set in the commands “/Width” and “/Height,” respectively, indicated by A2. The image data is drawn on the basis of the commands “/Width” and “/Height”. The unit of these values is dots (pixels).

In FIG. 6, the values of q1 through q6 derived from the following equations (1) through (6) are set in order in a setting formula which is indicated by A3 and which is made valid by the operators “q” and “Q”.
q1=Gx′ (1)
q2=0 (2)
q3=0 (3)
q4=Gy′ (4)
q5=max(Dx′,dx′) (5)
q6=Y′−(Gy′+max(Dy′,dy′)) (6)

where Gx′, Gy′, Dx′, Dy′, dx′, dy′, and Y′ indicate values obtained by converting the values of the above Gx, Gy, Dx, Dy, dx, dy, and y, respectively, by 72 dpi.

Of the values set in the setting formula indicated by A3, the first two values “q1, q2”(=“576.00 0”) indicate the position of the beginning of an image drawing area by coordinates. The next two values “q3, q4”(=“0 821.76”) indicate the position of the end of the image drawing area by coordinates. The rectangular image drawing area where a diagonal is a line segment which joins these two end points corresponds to the image size. The last two values “q5, q6”(=“8.50, 11.63”) indicate the position in the image drawing area in the page size where drawing is begun by coordinates. The unit of the values which indicate the positions of the beginning and end of the image drawing area is dots per inch.

As stated above, by performing the simple process of calculating the differential between the image size and the original size (standard paper size), the image file where the position of the image is identical to that of the image on the original can be generated.

Moreover, the image data is placed with the frame deletion size taken into consideration, so the image file (PDF file) where the position of the image is identical to that of the image on the original can be generated.

In addition, the image data is placed with the unreadable area size taken into consideration, so the image file (PDF file) where the position of the image is identical to that of the image on the original can be generated.

Furthermore, the image data is placed with one of the frame deletion size and the unreadable area size which actually influences the position of the image taken into consideration, so the image file where the position of the image is identical to that of the image on the original can be generated.

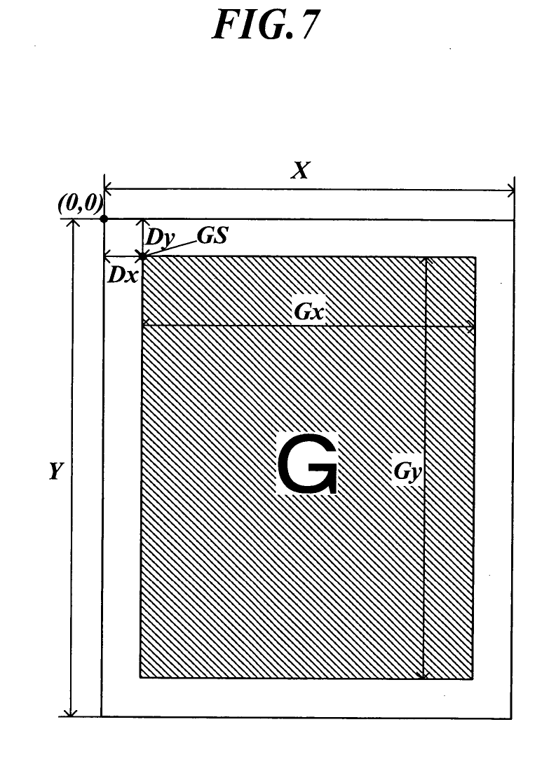

FIG. 7 is a view showing an example of a PDF file generated by the PDF generation section 68 on the basis of the one-page command shown in FIG. 6. It is assumed that Dx′>dx′ and that Dy′>dy′. As shown in FIG. 7, image data G is placed in an image drawing area (image size), the sizes of which are Gx and Gy, in a page size indicated by Px and Py with a point given by (q5, q6) (=(Dx′, Y′−(Gy′+Dy′)) as a position (GS in FIG. 7) where drawing is begun. In FIG. 7, the origin (0, 0) is at the upper left-hand corner of the page size indicated by Px and Py.

As stated above, the position where the image data is placed is designated by the one-page command. Therefore, the size of image data outputted is the same as that of the image on the original and a position where the image data is outputted is the same as that of the image on the original. In this case, the amount of the image data does not increase.

In step 191 in FIG. 4, if the determination that the paper size generation function is set to “invalid” is made (No in step S191), then the image size temporarily stored in the RAM 65 is obtained (step S196) and a page size which is equal to the image size is set (step S197).

The page size is then set as an image drawing area (step S198). On the basis of the page size and image drawing area set, a PDF file in which the image data is placed in the image drawing area is generated (step S195). Step S20 in FIG. 3 is then performed. In the step S20 in FIG. 3, the PDF file generated in step S19 is stored in the image memory 67 and the original reading process ends.

Operation performed in the original reading process and the PDF file generation process (steps S196 through S198) will now be described with reference to FIGS. 5, 8, and 9.

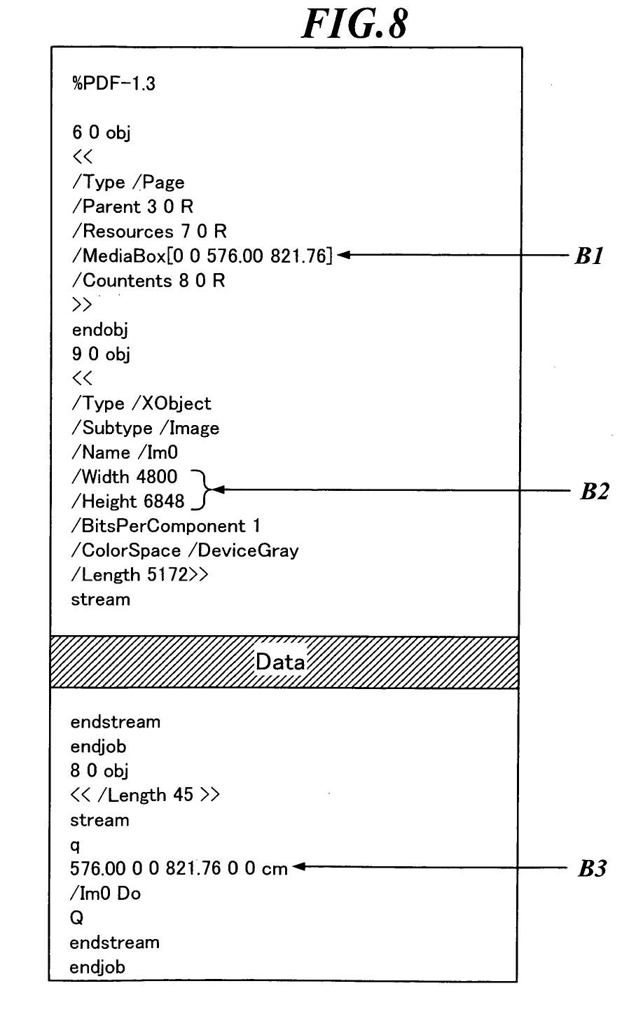

FIG. 8 is a view showing an example of a one-page command in a PDF file generated in the PDF file generation process. It is assumed that the values of the generation parameters for the PDF file are the same as those of the generation parameters shown in FIG. 6.

In FIG. 8, values obtained by converting a page size which is equal to an image size by 72 dpi are set in the command “/MediaBox” indicated by B1. The image sizes Gx=4800 and Gy=6848 are set in the commands “/Width” and “/Height,” respectively, indicated by B2. The unit of these values is dots (pixels).

In FIG. 8, the values of q1 through q6 derived from the following equations (7) through (12) are set in order in a setting formula which is indicated by B3 and which is made valid by the operators “q” and “Q”.
q1=Gx′ (7)
q2=0 (8)
q3=0 (9)
q4=Gy′ (10)
q5=0 (11)
q6=0 (12)

where Gx′ and Gy′ indicate values obtained by converting the values of the above Gx and Gy, respectively, by 72 dpi.

In this case, all of the values set in the command “/MediaBox,” the values set in the commands “/Width” and “/Height,” and the values made valid by the operators “q” and “Q” mean the same size, though they are represented in different manners.

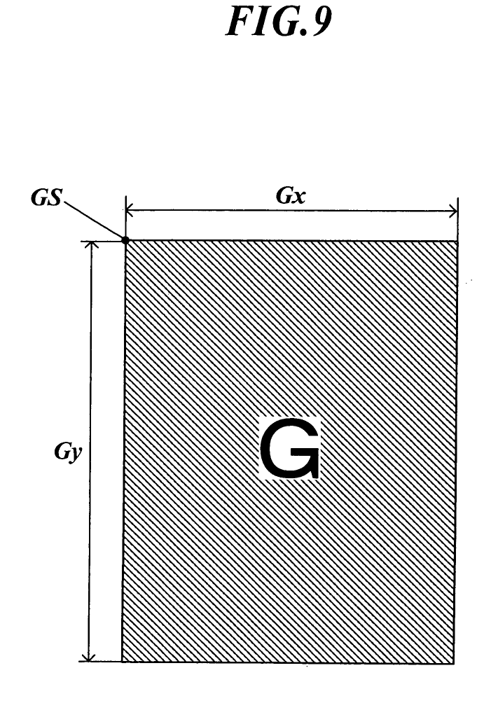

FIG. 9 is a view showing an example of a PDF file generated by the PDF generation section 68 on the basis of the one-page command shown in FIG. 8. As shown in FIG. 9, image data G is placed in an image drawing area, the sizes of which are Gx and Gy, in a page size indicated by Px and Py with a point given by (q5, q6) (=(0, 0)) as a position (GS in FIG. 9) where drawing is begun. That is to say, the PDF file the page size of which is equal to the image size is generated. In FIG. 9, the origin (0, 0) is at the upper left-hand corner of the page size indicated by Px and Py.

As stated above, in the image formation apparatus 100 according to the first embodiment the image file (PDF file) itself includes information regarding a size which is equal to the original size. Therefore, even if the size of image data generated by reading an image is smaller than the original size, the image data the size of which is equal to the original size can be outputted.

Furthermore, even if the size of image data generated by reading an image is non-standard, information regarding a standard paper size can be included in the image file (PDF file) itself.

In addition, the unreadable area size is stored in advance in the storage unit 66. Accordingly, by performing the simple process of reading the unreadable area size from the storage unit 66, the image file (PDF file) where the position of the image is identical to that of the image on the original can be generated.

### Second Embodiment

An image formation apparatus 100 according to a second embodiment of the present invention will now be described. To simplify explanation, the same components that are included in the above image formation apparatus 100 according to the first embodiment are marked with the same symbols and detailed descriptions of them will be omitted.

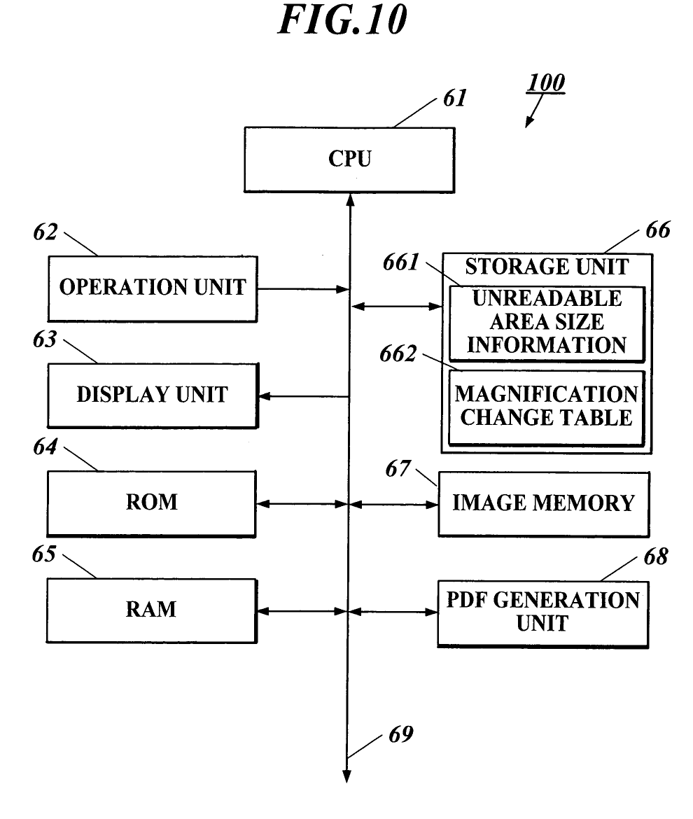

A reading control system 6 included in the image formation apparatus 100 according to the second embodiment will be described first with reference to FIG. 10.

In an operation unit 62, a magnification value at which an original size at reading time is enlarged or reduced can be designated by predetermined operation. A magnification value inputted by a user is outputted to a CPU 61.

The CPU 61 sets conditions for an original reading process described later by temporarily storing the above magnification value designated in a RAM 65.

A storage unit 66 stores in advance a magnification change table 662 in which magnification values are associated with page sizes (standard paper sizes such as A3, A4, and B4) according to original size types.

Under the control of the CPU 61, a PDF generation unit 68 refers to the magnification change table 662 stored in the storage unit 66, specifies an original size corresponding to the original size temporarily stored in the RAM 65, and sets the specified original size as the page size of a PDF file.

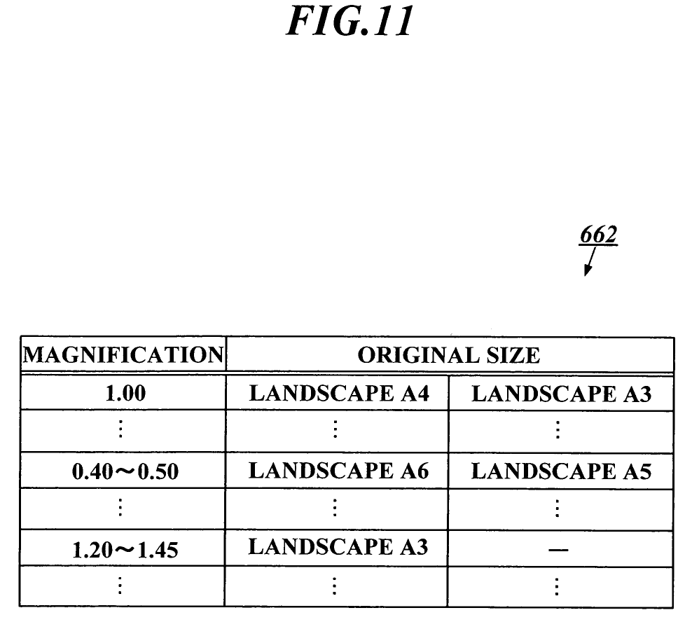

FIG. 11 is a view showing an example of the magnification change table 662 stored in the storage unit 66. In FIG. 11, original sizes (landscape A4 and landscape A3) at a magnification of 1.00 indicate types of the size of the original O and magnification values are associated with original sizes according to types of the size of the original O.

For example, if an original detection sensor 12 detects that an original size is “landscape A4,” and a magnification value of 0.40 is inputted via the operation unit 62, then the PDF generation unit 68 specifies landscape A6 as an original size corresponding to the original size “landscape A4” and the magnification value “0.40” and sets it as the page size of a PDF file.

The operation of the image formation apparatus 100 according to the second embodiment will now be described.

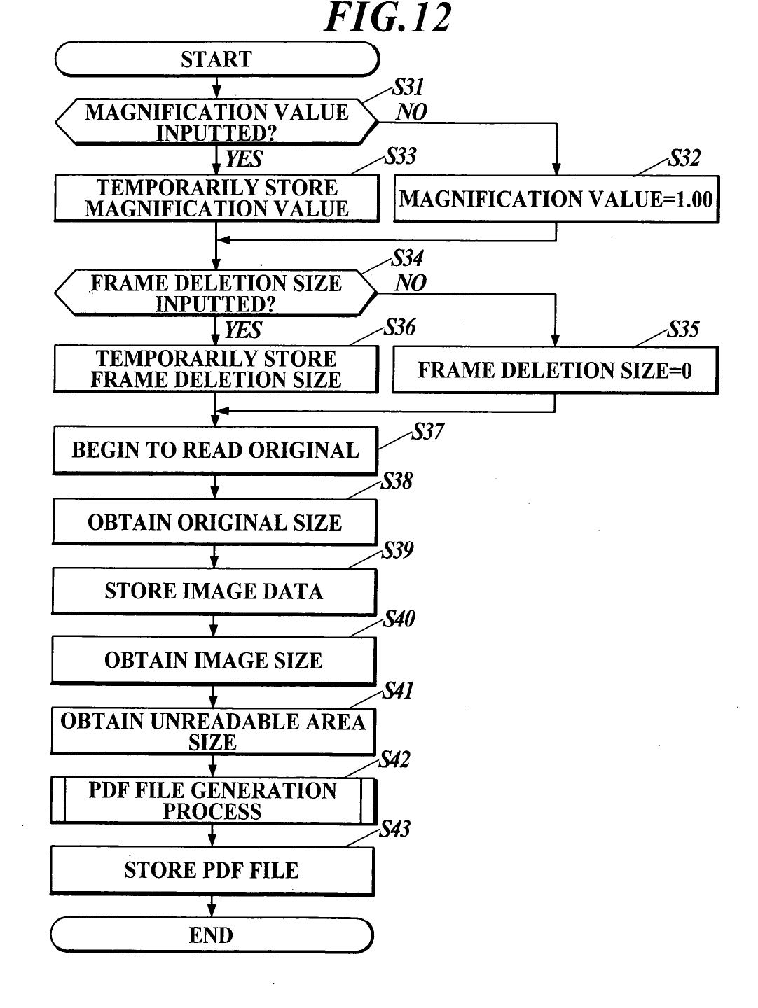

The procedure for an original reading process performed by the image formation apparatus 100 according to the second embodiment will be described first with reference to FIG. 12. Each process shown in FIG. 12 is performed with the cooperation of the CPU 61 and a predetermined program stored in a ROM 64 or the storage unit 66. It is assumed that the original O to be read is placed on the original feed unit 11.

Whether a magnification value has been inputted via the operation unit 62 is determined first (step S31) before the reading of the original O is begun. If the determination that a magnification value has not been inputted is made (No in step S31), then setting is performed by temporarily storing “magnification value=1.00” in the RAM 65 (step S32) and step S34 is performed. If the determination that a magnification value has been inputted is made (Yes in step S31), then setting is performed by temporarily storing the magnification value (1.4, for example) which has been inputted in the RAM 65 (step S33) and step S34 is performed.

In step S34, whether a frame deletion size has been inputted via the operation unit 62 is determined. If the determination that a frame deletion size has not been inputted is made (No in step S34), then setting is performed by temporarily storing “frame deletion size=0” in the RAM 65 (step S135) and step S37 is performed. If the determination that a frame deletion size has been inputted is made (Yes in step S34), then setting is performed by temporarily storing the frame deletion size which has been inputted in the RAM 65 (step S36) and step S37 is performed.

The reading of an image on the original O is then begun in accordance with an operation signal inputted via the operation unit 62 for giving instructions to begin to read (step S37). When an original size of the original O detected by the original detection sensor 12 is obtained, this original size is temporarily stored in the RAM 65 (step S38). The original O is fed to an image reading section 2 by an original feed mechanism (not shown) and image data is generated by the image reading section 2. The image data and the magnification value are multiplied together and image data obtained is stored in an image memory 67 (step S39). That is to say, in step S39 an electronic magnification change process is performed on the image data. If a reducing magnification value has been inputted, then a thinning process is performed. If an enlarging magnification value has been inputted, then an interpolation process is performed.

The image size of the image data stored in the image memory 67 is then obtained and is temporarily stored in the RAM 65 (step S40). When an unreadable area size stored in the storage unit 66 is obtained, each side of the unreadable area size and the magnification value are multiplied together and an unreadable area size obtained is temporarily stored in the RAM 65 (step S41). A PDF file generation process in step S42 is then performed.

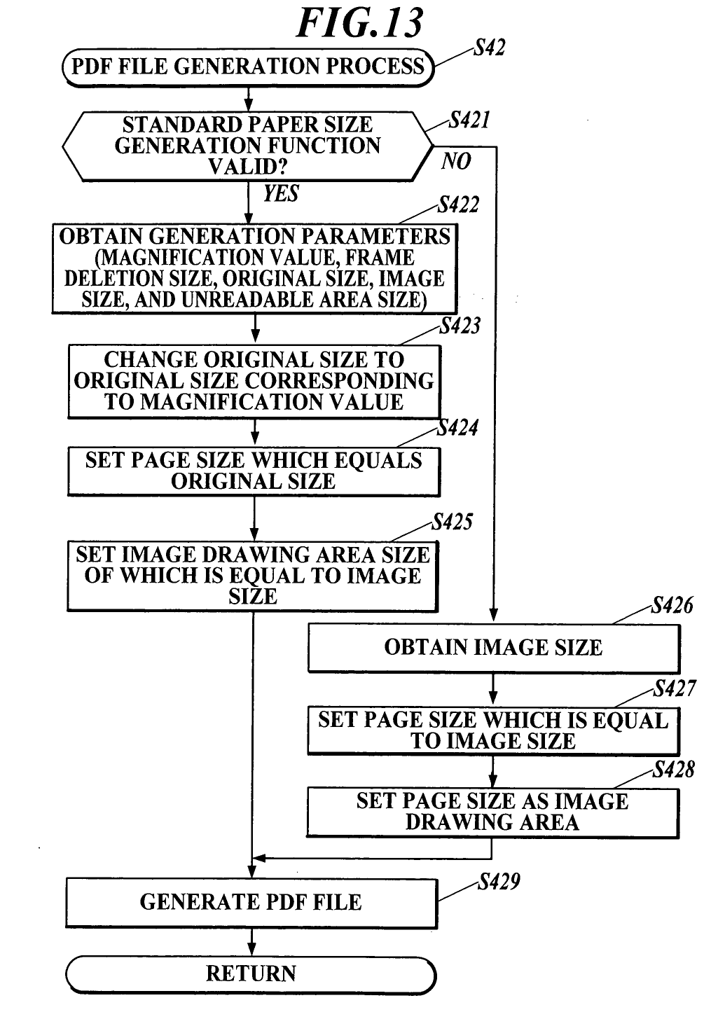

The PDF file generation process performed in step S42 will now be described with reference to FIG. 13. This process is performed by the PDF generation unit 68 under the control of the CPU 61.

Whether a paper size generation function is set to “valid” by a user via the operation unit 62 is determined first. If the determination that the paper size generation function is set to “valid” is made (Yes in step S421), then the parameters (magnification value, frame deletion size, original size, image size, and unreadable area size) temporarily stored in the RAM 65 are obtained (step S422). The magnification change table 662 stored in the storage unit 66 is referred to. When an original size corresponding to the above original size and magnification value is specified, the original size is changed to the specified original size (step S423).

A page size which is equal to the specified original size is then set (step S424). If the determination that an original size corresponding to the above original size and magnification value cannot be obtained is made, step S427 described later may be performed.

On the basis of the unreadable area size and the frame deletion size, an image drawing area the size of which is the same as the image size is set at a predetermined position in the page size (step S425). On the basis of the page size and image drawing area set, a PDF file in which the image data is placed in the image drawing area is generated (step S426). Step S43 in FIG. 10 is then performed.

In step 421, if the determination that the paper size generation function is set to “invalid” is made (No in step S421), then the image size temporarily stored in the RAM 65 is obtained (step S427) and a page size which is equal to the image size is set (step S428).

The page size is then set as an image drawing area (step S429). On the basis of the page size and image drawing area set, a PDF file in which the image data is placed in the image drawing area is generated (step S426). Step S43 in FIG. 12 is then performed.

In the step S43 in FIG. 12, the PDF file generated in step S42 is stored in the image memory 67 and the original reading process ends. In the case of printing, an image formation section 3 forms an image included in the PDF file stored in the image memory 67 at a position based on drawing instruction information on recording paper P the size of which corresponds to the above page size under the control of the CPU 61.

As stated above, with the image formation apparatus 100 according to the second embodiment, even if setting for a change in magnification is performed and an original is read, an image the size of which is the same as an original size (standard paper size) after the change in magnification can be outputted.

In addition, even if setting for a change in magnification is performed, an image the size of which is the same as an original size (standard paper size) after the change in magnification can be outputted by performing the simple process of referring to the magnification change table stored in advance in the storage unit 66.

The detailed structure or the detailed operation of the image formation apparatus according to the above embodiments can be changed properly without departing from the gist of the present invention.

In the above embodiments, for example, the unreadable area size is stored in advance in the storage unit 66 and is obtained by the CPU 61 at original reading time. However, the unreadable area size may be obtained from the differential between the original size and the image size obtained by the CPU 61.

Moreover, in the above embodiments the image data is placed in the page size on the basis of the unreadable area size or the frame deletion size. However, the image data may be placed at a predetermined position in the page size or be placed so that the central position of the page size will match the central position of the image data (centering).

Furthermore, in the above embodiments an original size is detected by the original detection sensor. However, another method for obtaining an original size may be used. For example, a standard size inputted from the operation unit by a user may be treated as an original size.

In addition, in the above second embodiment an electronic magnification change process is performed to enlarge/reduce an image at original reading time. However, an optical magnification change process may be performed instead or both an electronic magnification change process and an optical magnification change process may be performed.

Moreover, in the above embodiments the image files are generated in the PDF. However, an image file may be generated in the hypertext markup language (HTML) format, the TeX format, or the like.

The image formation apparatus and the image formation method according to the present invention can be actualized by a dedicated hardware circuit for performing each of the above procedures or by a CPU executing a program in which each of the above procedures is described. If the present invention is actualized by the latter method, the above program which makes an image formation apparatus run may be provided by a computer readable record medium, such as a floppy disk (registered trademark) or a CD-ROM, or be provided online via a network, such as the Internet. In this case, usually a program recorded on a computer readable record medium is transferred to a ROM, a hard disk, or the like and is stored thereon. In addition, this program may be provided as a single piece of application software or be incorporated into an image formation apparatus as software.

The present application is based on the entire disclosure, including the specification, claims, drawings, and abstract, of Japanese Patent Application No. Tokugan 2005-191903 filed with Japan Patent Office on Jun. 30, 2005.

What is claimed is:

1. An image reading apparatus comprising:
an image reading section for reading an original and for generating image data for the original;
an original size obtaining section for obtaining a size of the original; and
an image file generation section for setting a page frame which has a size equal to the size of the original obtained by the original size obtaining section, and for generating an image file including the set page frame and the image data.

2. The apparatus of claim 1, wherein the original size obtaining section includes a sensor for detecting the size of the original.

3. The apparatus of claim 1, wherein the image file generation section places the image data in the page frame based on a designated frame deletion size to generate the image file.

4. The apparatus of claim 1, wherein the image file generation section obtains an unreadable area size for the image reading section and places the image data in the page frame based on the unreadable area size to generate the image file.

5. The apparatus of claim 4, further comprising an unreadable area size storage section which stores in advance the unreadable area size for the image reading section, wherein the image file generation section obtains the unreadable area size from the unreadable area size storage section.

6. The apparatus of claim 4, wherein the image file generation section places the image data in the page frame based on the unreadable area size obtained based on difference between an image size and the size of the original to generate the image file.

7. The apparatus of claim 4, wherein the image file generation section generates the image file based on the frame deletion size or the unreadable area size, whichever is greater.

8. The apparatus of claim 1, wherein the image file generation section sets a page frame which has a size equal to the size of the original changed based on a magnification value designated and generates an image file including the page frame and image data generated according to the magnification value.

9. The apparatus of claim 8, further comprising a magnification change table storage section for storing a magnification change table in which the magnification value is associated with an original size corresponding to the magnification value for each original size type,
wherein the image file generation section changes the size of the original based on the magnification change table.

10. The apparatus of claim 1, wherein the image file is generated in a PDF format.

11. An image reading apparatus comprising:
an image reading section for reading an original and for generating image data; and
an image file generation section for setting a page frame having a standard paper size and for generating an image file including the set page frame and the image data.

12. The apparatus of claim 11, further comprising an original size obtaining section for obtaining the standard paper size, wherein the image file generation section sets the page frame based on the standard paper size obtained by the original size obtaining section.

13. The apparatus of claim 12, wherein the original size obtaining section includes a sensor for detecting a standard paper size of the original.

14. The apparatus of claim 11, wherein the image file generation section places the image data in the page frame based on a designated frame deletion size to generate the image file.

15. The apparatus of claim 11, wherein the image file generation section obtains an unreadable area size for the image reading section and places the image data in the page frame based on the unreadable area size to generate the image file.

16. The apparatus of claim 15, further comprising an unreadable area size storage section which stores in advance the unreadable area size for the image reading section, wherein the image file generation section obtains the unreadable area size from the unreadable area size storage section.

17. The apparatus of claim 15, wherein the image file generation section places the image data in the page frame based on the unreadable area size obtained based on difference between an image size and the standard paper size to generate the image file.

18. The apparatus of claim 15, wherein the image file generation section generates the image file based on the frame deletion size or the unreadable area size, whichever is greater.

19. The apparatus of claim 11, wherein the image file generation section sets a page frame which has a size equal to the standard paper size changed based on a magnification value designated and generates an image file including the page frame and image data generated according to the magnification value.

20. The apparatus of claim 19, further comprising a magnification change table storage section for storing a magnification change table in which the magnification value is associated with an original size corresponding to the magnification value for each original size type,
wherein the image file generation section changes a size of the original based on the magnification change table.

21. The apparatus of claim 11, wherein the image file is generated in a PDF format.

22. A computer readable medium storing a computer program for causing a computer to perform a method of:
obtaining image data from an image reading section;
obtaining a size of an original; and
setting a page frame which has a size equal to the size of the original obtained, and generating an image file including the set page frame and the image data.

23. A computer readable medium storing a computer program for causing a computer to perform a method of:
obtaining image data from an image reading section;
obtaining a standard paper size; and
setting a page frame which has a size equal to the standard paper size obtained, and generating an image file including the set page frame and the image data.
